(19) United States
(12) Patent Application Publication
(10) Pub. No.: US 2018/0173701 A1
(43) Pub. Date: Jun. 21, 2018

(54) METHOD FOR CONTENTS TAGGING AND ELECTRONIC DEVICE SUPPORTING THE SAME

(71) Applicant: Samsung Electronics Co., Ltd, Suwon-si (KR)

(72) Inventors: Seo Young Kim, Seoul (KR); Jin Sung Kim, Seoul (KR); Sang Heon Lee, Seoul (KR)

(21) Appl. No.: 15/844,393

(22) Filed: Dec. 15, 2017

(30) Foreign Application Priority Data
Dec. 16, 2016 (KR) 10-2016-0172661

(51) Int. Cl. G06F 17/30; G06F 3/0484

(52) U.S. Cl. CPC G06F 17/3002; G06F 17/30041; G06F 3/04842

(57) ABSTRACT

An electronic device is provided. The electronic device includes a communication module that supports communication with an external device, a memory that stores at least one part of content, and a processor electrically connected with the communication module and the memory. The processor is configured to tag at least one part of first content, which is acquired from the memory, and at least one part of second content, which is acquired from the memory or the external device, on each other based on a specified link factor and form link information between the at least one part of first content and the part of second content in a form of a table. Moreover, various embodiment found through the present specification are possible.

### CROSS-REFERENCE TO RELATED APPLICATION(S)

The present application is related to and claims priority to Korean Patent Application No. 10-2016-0172661 filed on Dec. 16, 2016, the entire disclosure of which is hereby incorporated by reference.

### TECHNICAL FIELD

The present disclosure relates to the construction of a content network based on tagging.

### BACKGROUND

Recently, as an electronic device equipped with an independent operating system has been rapidly spread, the electronic device may support not only a call function, but also various functions, such as a video or image capturing function, an Internet service function, a digital broadcast viewing function, a mobile function, or the like. The electronic device may create various types of multimedia content or download the multimedia content (or stream) in an operation for using the functions to store the multimedia content in an internal specified area of the electronic device.

### SUMMARY

As an amount of content to be stored in the electronic device become vast, a management system based on hierarchical classification has become increasingly desirable. Therefore, a tag functioning as a keyword for specific content has been suggested. However, the tag attached in the form of a text may have limitations in various expressions for content to be tagged. Further, since the tag in the form of the text may not effectively capture a user's intended expression, the experience of the user related to the content may feel disconnected.

Aspects of the present disclosure are to address at least the above-mentioned problems and/or disadvantages and to provide at least the advantages described below. To address the above-discussed deficiencies, it is a primary object to provide a method for tagging content and an electronic device supporting the same, capable of utilizing various types of multimedia content as tag objects.

Another aspect of the present disclosure is to provide a method for tagging content and an electronic device supporting the same, capable of constructing a content network based on tagging between multiple pieces of content.

In accordance with an aspect of the present disclosure, an electronic device may include a communication module that supports communication with an external device, a memory that stores at least one part of content, and a processor electrically connected with the communication module and the memory.

In accordance with another aspect of the present disclosure, the processor may tag at least one part of first content, which is acquired from the memory, and at least one part of second content, which is acquired from the memory or the external device, on each other based on a specified link factor and may form link information between the at least one part of first content and the at least one part of second content in a form of a table.

According to various embodiments, various tag scenarios may be employed by tagging various types of multimedia content on specific part of content.

According to various embodiments, the content network may be constructed by systematically tagging multiple pieces of content based on a specified link factor.

Besides, a variety of effects directly or indirectly understood through this disclosure may be provided.

Other aspects, advantages, and salient features of the disclosure will become apparent to those skilled in the art from the following detailed description, which, taken in conjunction with the annexed drawings, discloses various embodiments of the present disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates the configuration of an electronic device, according to certain embodiments of the present disclosure;

FIG. 2A illustrates a first screen related to content tagging, according to certain embodiments of the present disclosure;

FIG. 2B illustrates a second screen related to content tagging, according to certain embodiments of the present disclosure;

FIG. 2C illustrates a third screen related to content tagging, according to certain embodiments of the present disclosure;

FIG. 2D illustrates a fourth screen linked to the third screen related to content tagging, according to certain embodiments of the present disclosure;

FIG. 3A illustrates an example of an electronic device according to certain embodiments of the present disclosure in use;

FIG. 3B illustrates a screen related to content tagging according to certain embodiments of the present disclosure;

FIG. 4A illustrates a content tag screen, according to certain embodiments of the present disclosure;

FIG. 4B illustrates a first screen linked to the content tag screen, according to certain embodiments of the present disclosure;

FIG. 5A illustrates a content tag screen, according to certain embodiments of the present disclosure;

FIG. 5B illustrates a first screen linked to the content tag screen, according to certain embodiments of the present disclosure;

FIG. 5C illustrates a second screen linked to the content tag screen, according to certain embodiments of the present disclosure;

FIG. 6 illustrates a flowchart providing an example of a method for tagging content, according to certain embodiments of the present disclosure;

FIG. 7 illustrates a block diagram of an electronic device, according to certain embodiments of the present disclosure; and

FIG. 8 illustrates a block diagram of a program module, according to certain embodiments of the present disclosure.

Throughout the drawings, it should be noted that like reference numbers are used to depict the same or similar elements, features, and structures.

### DETAILED DESCRIPTION

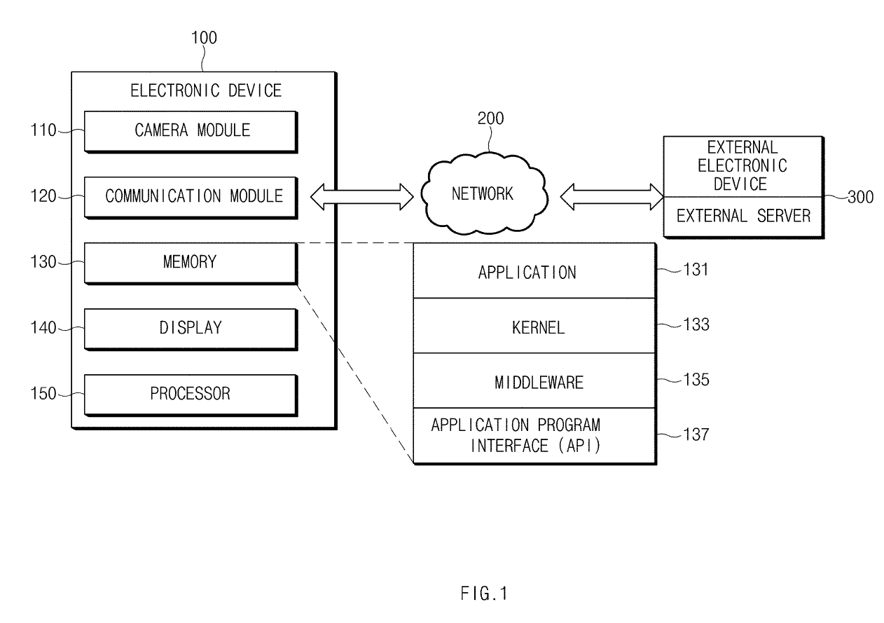

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, various embodiments of the present disclosure are disclosed with reference to the accompanying drawings. However, the present disclosure is not intended to be limited by the various embodiments of the present disclosure to a specific embodiment and it is intended that the present disclosure covers all modifications, equivalents, and/or alternatives of the present disclosure provided they come within the scope of the appended claims and their equivalents. With respect to the descriptions of the accompanying drawings, like reference numerals refer to like elements.

The terms and words used in the following description and claims are not limited to their dictionary definitions, but, are merely used to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include,” “comprise,” and “have”, or “may include,” or “may comprise” and “may have” used herein indicates disclosed functions, operations, or existence of elements but does not exclude other functions, operations or elements.

For example, the expressions “A or B,” or “at least one of A and/or B” may indicate A and B, A, or B. For instance, the expression “A or B” or “at least one of A and/or B” may indicate (1) at least one A, (2) at least one B, or (3) both at least one A and at least one B.

The terms such as “1st,” “2nd,” “first,” “second,” and the like as used herein may refer to modifying various different elements of various embodiments of the present disclosure, but are not intended to limit the elements. For instance, “a first user device” and “a second user device” may indicate different users regardless of order or importance. For example, a first component may be referred to as a second component and vice versa without departing from the scope and spirit of the present disclosure.

In various embodiments of the present disclosure, it is intended that when a component (for example, a first component) is referred to as being “operatively or communicatively coupled with/to” or “connected to” another component (for example, a second component), the component may be directly connected to the other component or connected through another component (for example, a third component). In various embodiments of the present disclosure, it is intended that when a component (for example, a first component) is referred to as being “directly connected to” or “directly accessed” another component (for example, a second component), another component (for example, a third component) does not exist between the component (for example, the first component) and the other component (for example, the second component).

The expression “configured to” used in various embodiments of the present disclosure may be interchangeably used with “suitable for,” “having the capacity to,” “designed to,” “adapted to,” “made to,” or “capable of” according to the situation, for example. The term “configured to” may not necessarily indicate “specifically designed to” in terms of hardware. Instead, the expression “a device configured to” in some situations may indicate that the device and another device or part are “capable of.” For example, the expression “a processor configured to perform A, B, and C” may indicate a dedicated processor (for example, an embedded processor) for performing a corresponding operation or a general purpose processor (for example, a central processing unit (CPU) or application processor (AP)) for performing corresponding operations by executing at least one software program stored in a memory device.

Terms used in various embodiments of the present disclosure are used to describe certain embodiments of the present disclosure, but are not intended to limit the scope of other embodiments. The terms of a singular form may include plural forms unless they have a clearly different meaning in the context. Otherwise, all terms used herein may have the same meanings that are generally understood by a person skilled in the art. In general, terms defined in a dictionary should be considered to have the same meanings as the contextual meaning of the related art, and, unless clearly defined herein, should not be understood differently or as having an excessively formal meaning. In any case, even the terms defined in the present specification are not intended to be interpreted as excluding embodiments of the present disclosure.

An electronic device according to various embodiments of the present disclosure may include at least one of a smartphone, a tablet personal computer (PC), a mobile phone, a video telephone, an electronic book reader, a desktop PC, a laptop PC, a netbook computer, a workstation, a server, a personal digital assistant (PDA), a portable multimedia player (PMP), a Motion Picture Experts Group (MPEG-1 or MPEG-2) Audio Layer 3 (MP3) player, a mobile medical device, a camera, or a wearable device. The wearable device may include at least one of an accessory-type device (e.g., a watch, a ring, a bracelet, an anklet, a necklace, glasses, a contact lens, a head-mounted device (HMD)), a textile- or clothing-integrated-type device (e.g., an electronic apparel), a body-attached-type device (e.g., a skin pad or a tattoo), or a bio-implantable-type device (e.g., an implantable circuit)

In some various embodiments of the present disclosure, an electronic device may be a home appliance. The smart home appliance may include at least one of, for example, a television (TV), a digital video/versatile disc (DVD) player, an audio, a refrigerator, an air conditioner, a cleaner, an oven, a microwave oven, a washing machine, an air cleaner, a set-top box, a home automation control panel, a security control panel, a television (TV) box (e.g., Samsung HomeSync™, Apple TV™, or Google TV™), a game console (e.g., Xbox™ or PlayStation™) an electronic dictionary, an electronic key, a camcorder, or an electronic picture frame

In other various embodiments of the present disclosure, an electronic device may include at least one of various medical devices (e.g., various portable medical measurement devices (e.g., a blood glucose measuring device, a heart rate measuring device, a blood pressure measuring device, a body temperature measuring device, or the like), a magnetic resonance angiography (MRA), a magnetic resonance imaging (MRI), a computed tomography (CT), a scanner, an ultrasonic device, or the like), a navigation device, a global navigation satellite system (GNSS), an event data recorder (EDR), a flight data recorder (FDR), a vehicle infotainment device, electronic equipment for vessels (e.g., a navigation system, a gyrocompass, or the like), avionics, a security device, a head unit for a vehicle, an industrial or home robot, an automatic teller machine (ATM), a point of sales (POS) device of a store, or an Internet of things (IoT) device (e.g., a light bulb, various sensors, an electric or gas meter, a sprinkler, a fire alarm, a thermostat, a streetlamp, a toaster, exercise equipment, a hot water tank, a heater, a boiler, or the like).

According to various embodiments of the present disclosure, an electronic device may include at least one of a part of furniture or a building/structure, an electronic board, an electronic signature receiving device, a projector, or a measuring instrument (e.g., a water meter, an electricity meter, a gas meter, a wave meter, or the like). An electronic device may be one or more combinations of the above-mentioned devices. An electronic device according to some various embodiments of the present disclosure may be a flexible device. An electronic device according to an embodiment of the present disclosure is not limited to the above-mentioned devices, and may include new electronic devices with the development of new technology.

Hereinafter, an electronic device according to various embodiments of the present disclosure will be described in more detail with reference to the accompanying drawings. The term “user” used herein may refer to a person who uses an electronic device or may refer to a device (e.g., an artificial intelligence electronic device) that uses an electronic device.

FIG. 1 illustrates the configuration of an electronic device, according to certain embodiments of the present disclosure. Hereinafter, operation of the content tagging may include operation of tagging of at least part of frame of the image content or at least part of the interval of the audio content. Alternatively, operation of the content tagging may include operation of tagging of at least part of various information related to the content (e.g., metadata, identification information, content creation date information, or content generation location information).

Referring to FIG. 1, an electronic device 100 may include a camera module 110, a communication module 120, a memory 130, a display 140, and a processor 150. According to various embodiments, the electronic device 100 may not include at least one of the above-described elements or may further include any other element(s).

According to at least one embodiment, the processor 150 may tag at least one part of second content on at least one part of first content which is selected under user control on the electronic device 100 or accompanied by the use of the function of the electronic device 100. In the operation of tagging the at least one part of second content on the at least one part of first content, the processor 150 may tag the at least one part of first content on the at least one part of second content, correspondingly tagging of the at least one part of second content on the at least one part of first content. On the basis of the tagging operation, the processor 150 may support employing various tag scenarios by constructing a content network for multiple pieces of content (e.g., the at least one part of first content and the at least one part of second content). Hereinafter, description will be made regarding various embodiments related to the above-described content tagging and elements of the electronic device 100 implementing the embodiments.

The camera module 110 may be mounted on one area of the electronic device 100 to capture an image (e.g., a still image or a video) of a surrounding area of the electronic device 100. According to certain embodiments, multiple camera modules 110 may be provided and the camera modules 110 may be disposed on the electronic device 100 to have mutually different angles of view (or at least partially overlapping angles of view) For example, the camera modules 110 may be disposed on opposite positions of the electronic device 100 to perform capturing in a first direction (e.g., in a front direction of the electronic device 100) and a second direction (e.g., in a rear direction of the electronic device 100) opposite to the first direction. In this case, the electronic device 100 may include an image editing program for editing (e.g., stitching) images captured by the camera modules 110. According to various embodiments, the camera module 110 may be fixed to a position in which the camera module 110 is disposed or at least a portion of the camera module 110 may be movable from the position under the user control. The image captured by the camera module 110 may be stored in the memory 130.

The communication module 120 may establish wired communication or wireless communication with an external device 300 (e.g., an external electronic device or an external server) according to a specified protocol and may be connected with a network 200 through the wired communication or the wireless communication. The communication module 120 may interact with the external device 300 via the network 200. For example, the communication module 120 may receive at least one content (e.g., an image, a text, a video, a voice, a sound, a sign, a symbol, an icon, or the like) from the external device 300. The network 200 may include at least one of a computer network (e.g., a local area network (LAN) or a wired area network (WAN)), the Internet, or a telephone network. According to various embodiments, the wireless communication may employ at least one of long term evolution (LTE), LTE-advanced (LTE-A), code division multiple access (CDMA), wideband CDMA (WCDMA), universal mobile telecommunications system (UMTS), wireless broadband (WiBro), or global system for mobile communications (GSM). The wireless communication may include short range radio communication, such as wireless fidelity (Wi-Fi), Bluetooth, near field communication (NFC), or magnetic stripe transmission (MST).

The memory 130 may store at least one part of content. For example, the memory 130 may store content based on an image captured by the camera module 110 or may store content downloaded (or streamed) from the external device 300. In addition, the memory 130 may store at least one of data, an instruction, or a program related to the use of the function of the electronic device 100. The program may include, for example, an application program 131 (e.g., a web-browser, a photo gallery, a music player, a calendar, a notepad, or the like), a kernel 133, a middleware 135, or an application programming interface (API) 137.

The kernel 133 may control or manage system resources (e.g., the memory 130 or the processor 150) necessary for performing the operation or the function implemented through other programs (e.g., the application program 131, the middleware 135, or the API 137). In addition, the kernel 133 may provide an interface allowing the application program 131, the middleware 135, or the API 137 to access an individual element of the electronic device 100 to control or manage the system resources.

The middleware 135 may perform, for example, a mediation role such that the application program 131 or the API 137 communicates with the kernel 133 to transmit or receive data. Furthermore, the middleware 135 may process one or more task requests received from the application program 131 in order of priorities. For example, the middleware 135 may assign the priority, which makes it possible to use a system resource (e.g., the memory 130 or the processor 150) of the electronic device 100, to at least one of application programs 131. The middleware 135 may perform scheduling, load balancing, or the like for the one or more task requests in order of priorities.

The API 137 may be an interface allowing the application program 131 to control a function provided by the kernel 133 or the middleware 135, and may include, for example, at least one interface or function (e.g., an instruction) for a file control, a window control, image processing, a character control, or the like. According to various embodiments, the memory 130 may include at least one of a volatile memory (e.g., a dynamic random access memory (DRAM), a static RAM (SRAM), or a synchronous DRAM (SDRAM)), a nonvolatile memory (e.g., a one-time programmable read only memory (OTPROM), a programmable ROM (PROM), an erasable and programmable ROM (EPROM), an electrically erasable and programmable ROM (EEPROM) or the like), a mask ROM, a flash ROM, or a flash memory.

The display 140 may output related content corresponding to a user input (e.g., a touch, a drag, a swipe, a hovering, or the like) or a capturing operation of the camera module 110. In addition, the display 140 may output an execution screen of the application program 131 including at least one content. According to certain embodiments, regarding execution of the function (e.g., content tagging) of the processor 150, the display 140 may output a user interface (e.g., a screen showing a tag relation between multiple pieces of content) related to the execution of the function of the processor 150 or may output a reproduction screen according to attributes of the content. According to various embodiments, the display 140 may include, for example, a liquid crystal display (LCD), a light-emitting diode (LED) display, an organic LED (OLED) display, a microelectromechanical systems (MEMS) display, or an electronic paper display. According to various embodiments, the display 140 may include a touch screen. The display 140 may receive a user input based on the touch screen by using, for example, the body of a user (e.g., a finger) or an electronic pen.

The processor 150 can be electrically or operatively connected with other elements of the electronic device 100 to perform a control, a communication computation, or data processing for the elements. For example, the processor 150 may classify at least one content stored in the memory 130 based on a specified category (e.g., the type of an object included in the content, the creation date of the content, or the creation location of the content) and may store the classified content in a database. In addition, the processor 150 may construct, for example, a content network in which the multiple pieces of content are systematically linked to each other, based on a tagging control between the multiple pieces of content. In the operation for constructing the content network, the processor 150 may store related information (e.g., information on the link between the multiple pieces of content) between the multiple pieces of content, which are tagged on each other, in the form of a table in the memory 130. According to various embodiments, the processor 150 may include at least one of a central processing unit (CPU), an application processor (AP), or a communication processor (CP).

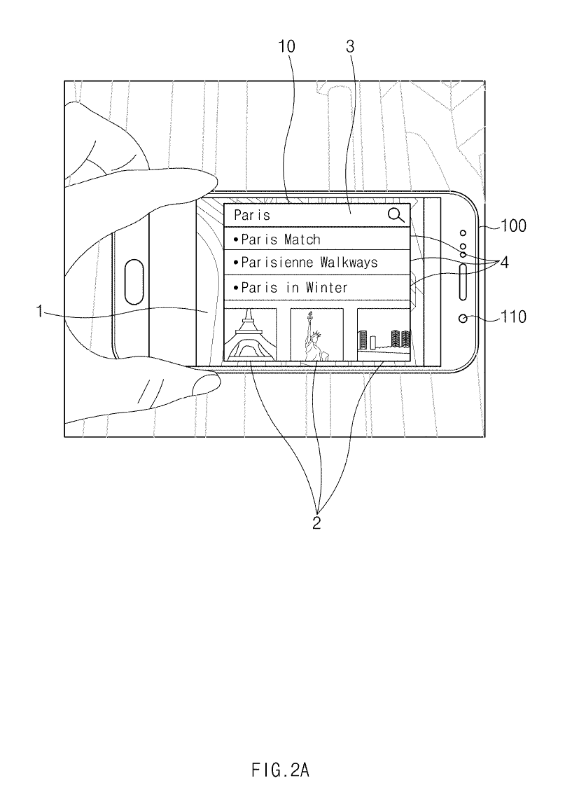

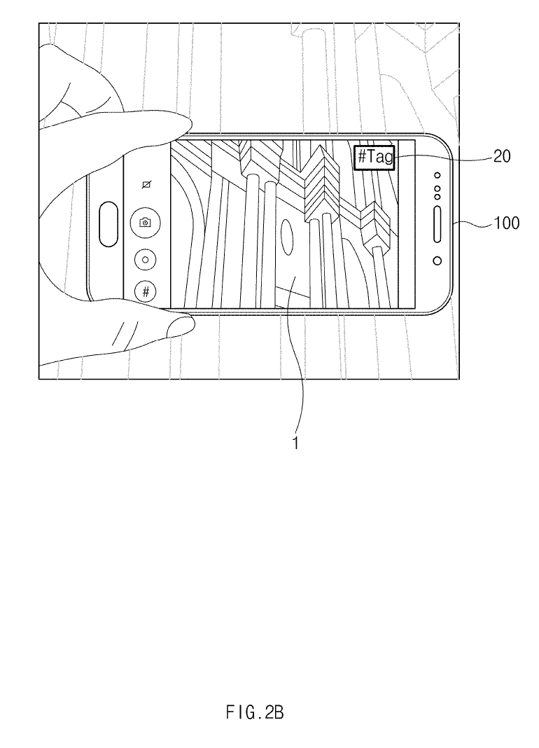

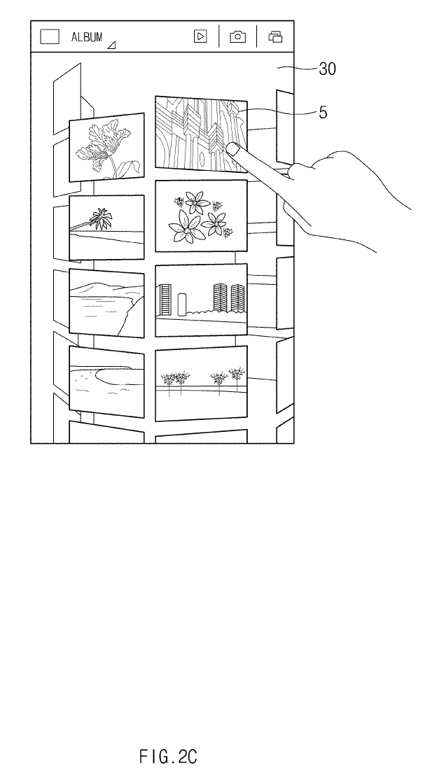

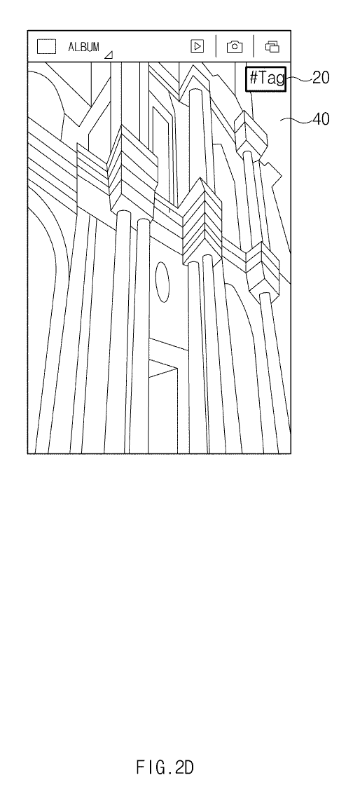

FIGS. 2A, 2B, 2C, and 2D illustrate various screens related to content tagging, according to certain embodiments.

Referring to FIG. 2A, the electronic device 100 may acquire or create at least one content in an operation of using an embedded function of the electronic device 100. For example, the electronic device 100 may create content 1 by capturing an image (e.g., a still image or a video) of a surrounding area (or a specific subject) by using at least one camera module 110 disposed on one area of the electronic device 100. In addition, a processor (see reference numeral 150 of FIG. 1) may output a tagging interface for supporting tagging on the at least one part of first content 1 (part of first content), which is created through the capturing of the at least one camera module 110, at creation time of the at least one part of first content 1 by the at least one of camera module 110 or at the storage time of the at least one part of first content 1. In outputting a tagging interface 10, the processor 150 may collect information related to the at least one part of first content 1 and may extract at least one content (part of second content), which has a connection with the information of the part of first content 1, from a database (e.g., a database having at least one content classified according to a specified category) constructed in the memory 130. For example, the processor 150 may determine the type of a subject (or an object) related to the part of first content 1 through image analysis and may extract at least one part of second content similar to or corresponding to the subject related to the part of first content 1 from the database. Alternatively, the processor 150 may acquire creation location information of the part of first content 1 by making reference to metadata of the part of first content 1 and may extract at least one part of second content similar to or corresponding to the location information of the part of first content 1 from the database. The processor 150 may designate the at least one part of second content, which is extracted from the database, as, for example, a tag object recommended for the part of first content 1 and may include the at least one part of second content in one area 2 of the tagging interface 10. The processor 150 may determine the at least one part of second content, which receives the user input (e.g., a touch) on the tagging interface 10, as the tag object for the part of first content 1.

According to certain embodiments, the processor 150 may include a search window 3, which is used for supporting web-search, in one area of the tagging interface 10. Accordingly, in the case where a user input (e.g., a touch) is applied to the search window 3, for example, a software input panel (SIP) keyboard may be output onto at least a portion of a screen area of the electronic device 100 or at least a portion of an area of the tagging interface 10. A user may input a specific search word into the search window 3 through the SIP keyboard. Accordingly, the screen of the electronic device 100 including the tagging interface 10 may be switched to a screen on which a specified webpage is displayed. Alternatively, according to system settings related to the tagging interface 10, the screen of the electronic device 100 may be switched to an execution screen of a specific application program (e.g., a photo gallery, a music player, a calendar, a notepad, or the like) when the search word of the user is input. At least one content related to the search word may be included in the switched screen of the webpage or the execution screen of the application program, and the user may download (or stream) content or may select the content. In this case, the screen of the webpage or the execution screen of the application program may be switched to the screen of the tagging interface 10 again, and at least one content downloaded or selected by the user may be included in one area of the tagging interface 10. According to certain embodiments, in the case where the search word is input into the search window 3, the processor 150 may receive a related search word 4 from a specified external server or an external server related to the search word. In other words, the processor 150 may display at least one related search word 4, which is received, in the lower area of the search window 3.

Referring to FIG. 2B, the processor 150 may not output a tagging interface (reference numeral 10 of FIG. 2A) by taking into consideration the visibility of the part of first content 1 created through the capturing of the at least one camera module 110. In this case, the processor 150 may output a tag tab 20, which is used for supporting the tagging interface 10, to one area of the electronic device 100 at the creation time or the storage time for the part of first content 1. According to certain embodiments, in the case in which a user input (e.g., a touch) is applied onto the tag tab 20, the processor 150 may output the tagging interface 10 onto the screen of the electronic device 100. Alternatively, the processor 150 may switch the screen of the electronic device 100 including the part of first content 1 to an additional screen including the tagging interface 10 in response to the user input applied onto the tag tab 20.

Referring to FIGS. 2C and 2D, the processor 150 may output a tagging interface (reference numeral 10 of FIG. 2A) under a user control, in_addition to the operation of using a function through the camera module 110. Accordingly, a user may apply an input (e.g., a touch) to content 5 (e.g., an image, a video, a voice, a sound, or the like) which is to be designated as a part of tagging target content and is displayed on the execution screen of the application program 131 (e.g., a photo gallery, a music player, or the like) including at least one content). The processor 150 may output a screen 40 related to the content 5 in response to the user input. The content 5 may be expanded in a specified ratio (e.g., in the case of an image or the like) or may be reproduced (e.g., in the case of a video, a voice, a sound, or the like) according to related attributes, on the screen 40. According to certain embodiments, the processor 150 may output the tag tab 20 onto at least a portion of the area of the screen 40 while outputting the screen 40 or within a specified time from the output of the screen 40. In the case in which the user input (e.g., a touch) is applied to the tag tab 20, the processor 150 may output (e.g., overlapping) the tagging interface 10 onto at least a portion of the area of the screen 40 or may switch the screen 40 to an additional screen including the tagging interface 10. According to certain embodiments, at least one content may be included in the tagging interface 10 with a connection with the content 5, which is selected as the part of tagging target content by the user, in terms of subject information, location information, or creation date information.

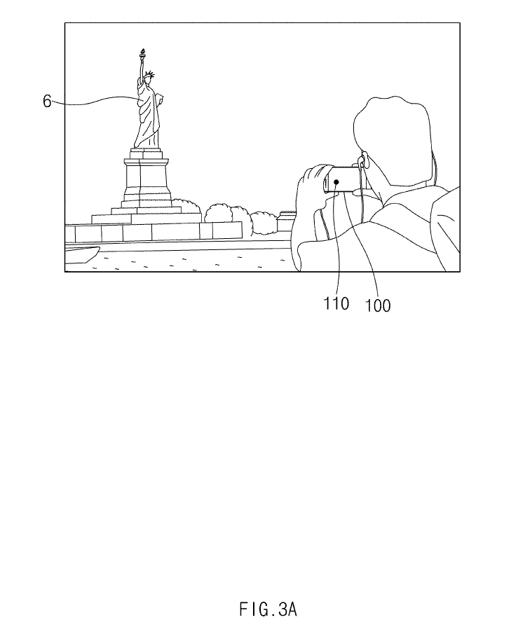

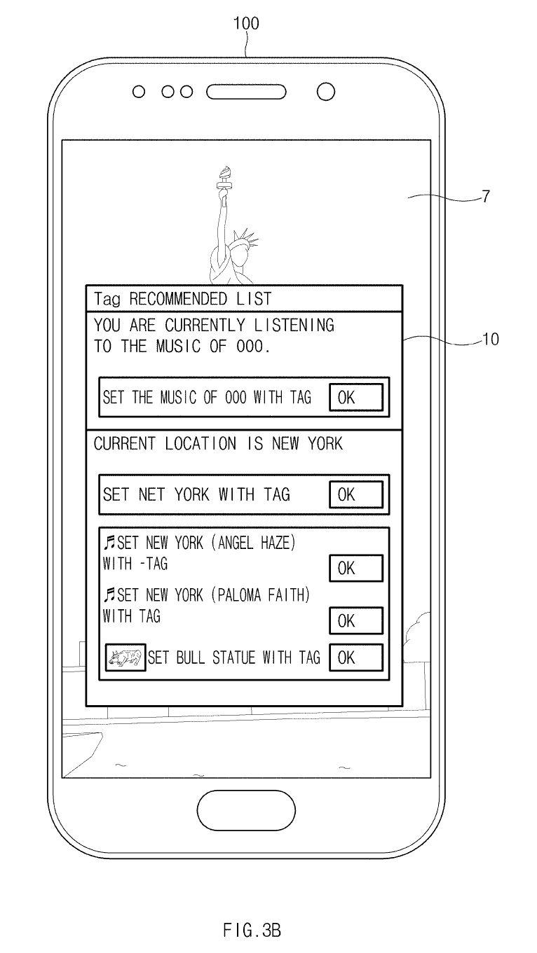

FIG. 3A is a view illustrating the use of the electronic device according to another embodiment, and FIG. 3B is a view illustrating a screen related to content tagging according to another embodiment.

Referring to FIG. 3A, the electronic device 100 may perform a plurality of functions under the user control. For example, the electronic device 100 may photograph a surrounding area by the at least one camera module 110 while outputting a specified sound (e.g., music) through a speaker module (not illustrated) mounted in the electronic device 100. Alternatively, the electronic device 100 may perform a control operation to activate any one of the photographing function or the function of outputting the sound and, after a specific time elapses, to deactivate the activated function and to activate the other function. For example, the functions of the electronic device 100 may be integrally performed at the same time or may be individually performed at specific time intervals under the user control. According to certain embodiments, a processor (reference numeral 150 of FIG. 1) may form a tagging interface (e.g., reference numeral 10 of FIG. 2A) for supporting content tagging under the operating environment of the electronic device 100. For example, the processor 150 may include at least one content, which is related the functions, in the form of a list in the tagging interface 10 in the case in which the functions are performed on the electronic device 100 (in the case in which the functions are performed at specific time intervals).

Referring to FIGS. 3A and 3B, the processor 150 may output a tagging interface 10 at the creation time of content 7 created through the capturing of a subject 6 or at the storage time of the content 7. In addition, the processor 150 may display a tag tab (not illustrated (e.g., reference numeral 20 of FIG. 2D) on a portion of a screen area of the electronic device 100 at the creation time or storage time of the content 7 and may output the tagging interface 10 in response to a user input (e.g., a touch) to the tag tab. According to certain embodiments, a list specifying at least one content related to the operating environment of the electronic device 100 may be included in the tagging interface 10. For example, as the electronic device 100 is outputting a sound (e.g., music) or has used a function of outputting a sound before specific time from the capturing of the subject 6, at least one content related to the outputting of the sound may be included in the list. Alternatively, in the case in which the database constructed in the memory (reference numeral 130 of FIG. 1) has content related to the subject 6 (e.g., the Statue of Liberty) included in the content 7 created through the capturing, the content related to the subject 6 may be included in the list. Alternatively, in the case in which the subject 6 detected through the image analysis for the content 7 is determined as a landmark related to a specific area or the location information of the content 7 is acquired by making reference to the metadata of the content 7, content corresponding to the area or the location information may be extracted from the database and may be included in the list. According to certain embodiments, in the case in which the user input (e.g., a touch) is applied to one area (e.g., an OK tab) of the list, the processor 150 may determine content corresponding to the user input as a tag object for the content 7 created through the capturing function. According to various embodiments, the list included in the tagging interface 10 is not limited to a list created from the capturing function or the sound output function of the electronic device 100, but the list may include various pieces of content related to the operating environment of the electronic device 100.

According to various embodiments described above, the processor 150 may determine content, which is accompanied by the operation of using a function of the electronic device 100 or is selected by a user on an execution screen of a specific application program, to be, for example, a part of tagging target content (part of first content). In addition, the processor 150 may determine at least one content which is output onto a screen for the part of first content or is selected by the user on the tagging interface 10 linked to the screen for the part of first content, to be a part of tag object content (part of second content). Accordingly, the processor 150 may include metadata information or identification information of the part of second content in metadata of the part of first content to tag the part of second content on the part of first content. In tagging operation, the processor 150 may include metadata information or identification information of the part of first content in the metadata of the part of second content to tag the part of first content on the part of second content, which corresponds to the tagging operation of the part of second content. Accordingly, the processor 150 may construct a content network for multiple pieces of content. The processor 150 may, through the content network, identify or extract the part of second content and at least one third content having a tag relation with the part of second content from the part of first content.

According to certain embodiments, the processor 150 may form a table for multiple pieces of content having a tag relation therebetween in the memory 130. The table may include link information between the multiple pieces of content having the tag relation. For example, the processor 150 may include at least one of metadata information or identification information (e.g., a URL, a URI, or the like) of each of the part of first content and the part of second content having a tag relation therebetween, or link factor information (e.g., subject information included in content, creation date information of the content, creation location information of the content, or the operating environment information of the electronic device) between the part of first content and the part of second content, in the table as the link information. According to certain embodiments, the table may support the access to the part of second content based on the part of first content. In addition, the table may support rapid data processing of the processor 150 by excluding the verification of the metadata accompanied in the identification of the tag relation between the multiple pieces of content.

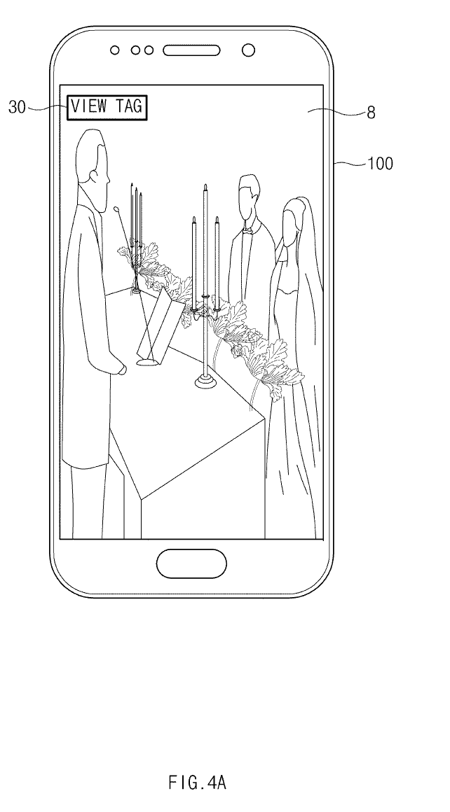

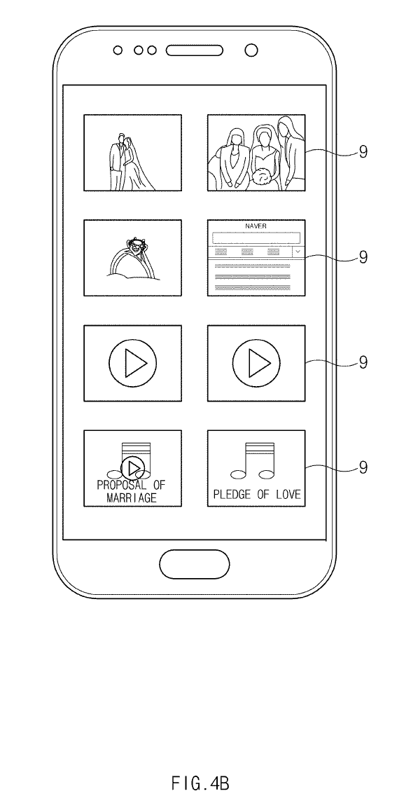

FIG. 4A illustrates a content tag screen, according to certain embodiments, and FIG. 4B illustrates a first screen linked to the content tag screen, according to certain embodiments.

Referring to FIGS. 4A and 4B, according to at least one embodiment, a processor (see reference numeral 150 of FIG. 1) may display multiple pieces of content, which are tagged on each other, through a specific application program (e.g., an application program supporting the display of content to which the tag function is applied). The processor 150 may display a part of tagging target content 8 and at least one part of tag object content 9, which have a tag relation therebetween, on an additional screen (or an interface), when executing the specific application program For example, if the part of tagging target content 8 is selected under user control after the application program is performed, the processor 150 may display a tag tab 30 for switching on one area of a screen for the part of tagging target content 8. According to various embodiments, the tag tab 30 may be translucently displayed to ensure the visibility of the part of tagging target content 8. The tag tab 30 may be removed in response to a specified user input (e.g., a press and hold kept for specified time or more). According to certain embodiments, in the case in which a user input (e.g., a touch) is applied onto the tag tab 30, the processor 150 may switch the screen for the part of tagging target content 8 to a screen including at least one part of tag object content 9 tagged on the part of tagging target content 8. The at least one part of tag object content 9 may be arranged, on the switched screen, in a form including a plurality of areas having the same size or sizes corresponding to each other. The processor 150 may expand, in response to a user input (e.g., a touch) applied to any one of the at least one part of tag object content 9, the size of the relevant content to a specified size to display the expanded content, or may reproduce the relevant content (e.g., in the case of a video, a sound, or a voice).

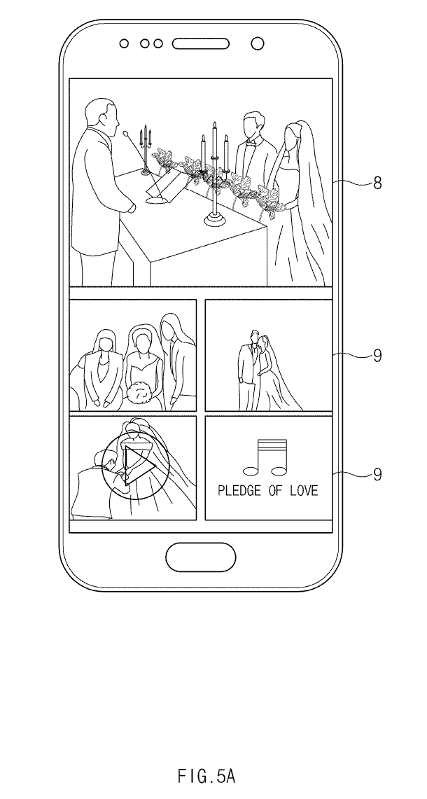

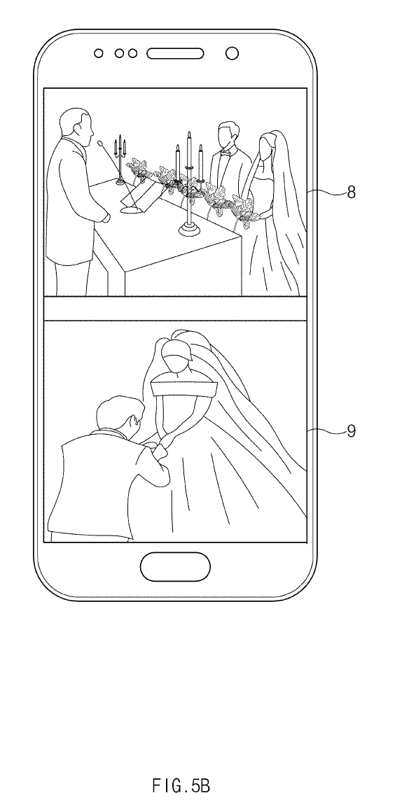

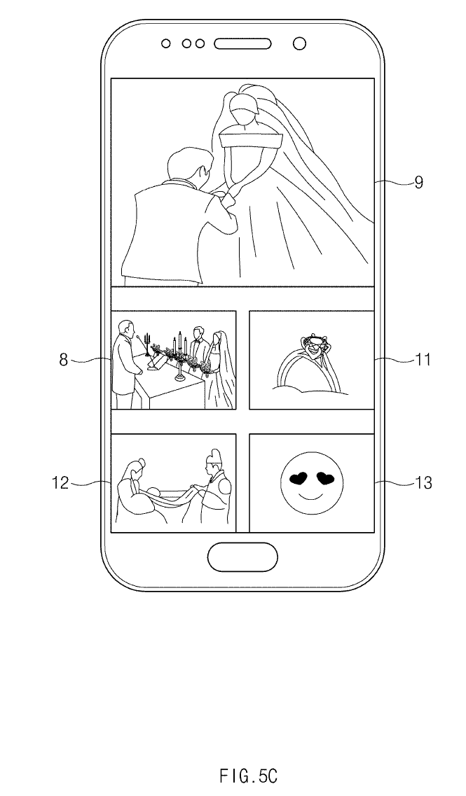

FIG. 5A illustrates a content tag screen, according to certain other embodiments, and FIG. 5B and FIG. 5C illustrates various screens linked to the content tag screen, according to other embodiments.

Referring to FIG. 5A, according to certain embodiments, a processor (reference numeral 150 of FIG. 1) may display multiple pieces of content having a tag relation therebetween through the above-described specific application program. For example, the processor 150 may arrange a part of tagging target content 8 and at least one part of tag object content 9 on a single screen. In addition, the processor 150 may divide the execution screen of the specific application program into a plurality of areas. For example, the processor 150 may divide the execution screen of the specific application program into a first area and at least one second area smaller than the first area. According to certain embodiments, the processor 150 may dispose the part of tagging target content 8 in the first area and dispose at least one part of tag object content 9 in the at least one second area.

According to various embodiments, the at least one second area may slide in a specified direction in response to a specified user input (e.g., a drag), based on the number of the at least one part of tag object content 9. Alternatively, the at least one second area may slide in a specified direction at a specified speed regardless of the user input (e.g., the drag). According to various embodiments, the at least one part of tag object content 9 disposed in the at least one second area may be displayed or may not displayed on the screen area of the electronic device 100, correspondingly to the sliding of the second area.

According to various embodiments, the processor 150 may create an interface including at least one content, which is related to a music, a sound, or a voice, of the at least one part of tag object content 9. For example, the interface may be, for example, displayed in the form of a preview on any one of the at least one second area. In the case in which the user input (e.g., a touch) is applied to the interface, the processor 150 may output the interface and may reproduce at least one video, sound, or voice content, which is included in the interface, in a specified sequence.

Referring to FIGS. 5A and 5B, according to certain embodiments, a user input may be applied to any one of at least one part of tag object content 9 included in the second area. The processor 150 may expand the size of the part of tag object content 9, to which the user input is applied, to a size equal to or approximate to the size of the part of tagging target content 8. In the operation expanding the size of the part of tag object content 9, the processor 150 may determine the attribute of the part of tag object content 9 and may reproduce the part of tag object content 9 in the expanded state in the case in which the determined attribute is a video, a sound, or a voice.

Referring to FIGS. 5B and 5C, according to certain embodiments, in the case in which the user input (e.g., a touch) is applied to the part of tag object content 9 in an expanded state, the part of tag object content 9 may be disposed in the first area (or, an upper area) on the execution screen of the specific application program. For example, the part of tag object content 9 subject to the user input may be disposed in the first area while pushing the part of tagging target content 8 disposed at the upper area of the execution screen of the specific application program. According to another embodiment, the screen including the part of tag object content 9 and the part of tagging target content 8 may be switched to an additional screen having the first area in which the part of tag object content 9 subject to the user input is disposed. According to certain embodiments, at least one part of content 8, 11, 12, and/or 13 tagged on the part of tag object content 9 may be displayed under the part of tag object content 9 disposed in the first area. Identically or correspondingly to the above description made with reference to FIG. 5A, the at least one part of content 8, 11, 12, and/or 13 tagged on the part of tag object content 9 may be displayed while being manipulated by a user input (e.g., a drag) or at a specified speed. At least one video content, sound content or voice content of the at least one part of content 8, 11, 12, and/or 13 tagged on the part of tag object content 9 may be included in an additional interface to be displayed in the form of a preview.

According to various embodiments, an electronic device may include a communication module that supports communication with an external device, a memory that stores at least one part of content, and a processor electrically connected with the communication module and the memory.

According to various embodiments, the processor may tag at least one part of first content, which is acquired from the memory, and at least one part of second content, which is acquired from the memory or the external device, on each other based on a specified link factor and may form link information between the at least one part of first content and the at least one part of second content in a form of a table.

According to various embodiments, the processor may output a user interface, which supports tagging settings between the at least one part of first content and the at least one part of second content, onto at least a portion of a screen area for the at least one part of first content.

According to various embodiments, the processor may include at least one part of second content, which includes an object corresponding to the at least one part of first content, in at least one area of the user interface.

According to various embodiments, the processor may include at least one part of second content, which includes location information corresponding to the at least one part of first content, in at least one area of the user interface.

According to various embodiments, the processor may include at least one part of second content, which includes date information corresponding to the at least one part of first content, in at least one area of the user interface.

According to various embodiments, the processor may include at least one part of content related to use of multiple functions in the user interface, if the multiple functions of the electronic device are simultaneously and integrally used.

According to various embodiments, the processor may determine at least one part of first content, which is accompanied in an operation of using a function of the electronic device or is selected from an execution screen of a specific application program by a user, as a part of tagging target content.

According to various embodiments, the processor may determine at least one part of second content, which is selected from the user interface by a user, as a part of tag object content.

According to various embodiments, the processor may include metadata information or identification information of the at least one part of second content in metadata of the at least one part of first content to tag the at least one part of second content on the at least one part of first content.

According to various embodiments, the processor may include metadata information or identification information of the at least one part of first content in metadata of the at least one part of second content to tag the at least one part of first content on the at least one second content, if the at least one second content is tagged on the at least one part of first content.

According to various embodiments, the processor may include, in the table, at least one of metadata information or identification information of each of multiple pieces of content having a tag relation between the multiple pieces of content, or link factor information between the multiple pieces of content.

According to various embodiments, the processor may include the at least one part of first content and the at least one part of second content in a single screen of an execution screen of an application program related to the tagging.

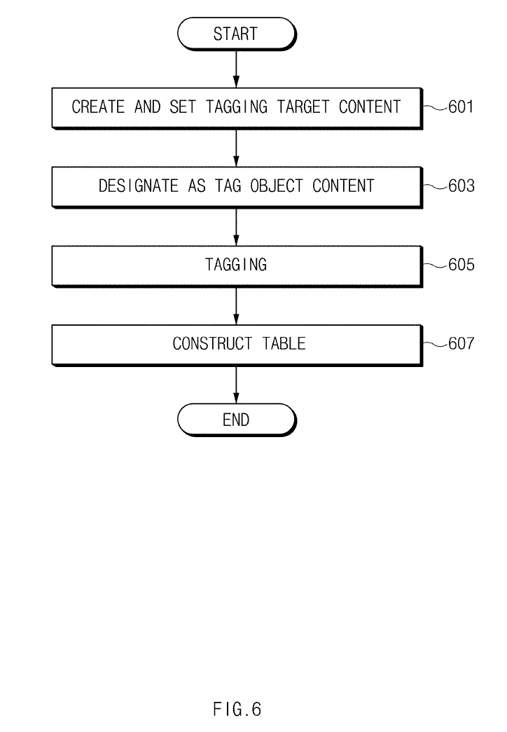

FIG. 6 illustrates a flowchart of a method for tagging content, according to certain embodiments.

Referring to FIG. 6, in operation 601, a processor (see reference numeral 150 of FIG. 1) may create a part of tagging target content in an operation of using a function of an electronic device (see reference numeral 100 of FIG. 1). For example, the processor may control at least one camera module (reference numeral 110 of FIG. 1) included in one area of the electronic device to capture a surrounding environment or a specific subject and thus may create a part of tagging target content on which a specific content is tagged. Alternatively, the processor may designate specific content, which is selected from an execution screen of an application program (e.g., a photo gallery, a music player, a webpage, or the like) including at least one content in response to a user input (e.g., a touch), as the part of tagging target content.

In operation 603, the processor may output a tagging interface, which is used for supporting content tagging, onto a screen of the part of tagging target content, according to specified scheduling information or under user control. Alternatively, the processor may output a tagging interface through an additional screen linked to a screen of the part of tagging target content. The tagging interface may include at least one part of content having connections with the part of tagging target content in terms of subject information, location information, or date information. According to various embodiments, in the case in which the electronic device performs multiple functions (e.g., content capturing and sound outputting) together, the tagging interface may include at least one content related to the functions. The processor may designate, as a part of tag object content for the part of tagging target content, at least one specific content, to which a user input is applied, on the tagging interface.

In operation 605, the processor may include metadata information or identification information of the selected part of tag object content in metadata of the part of tagging target content, thereby tagging the part of tag object content on the part of tagging target content. Alternatively, the processor may include metadata information or identification information of the part of tagging target content in metadata of the part of tag object content, thereby constructing a network between multiple pieces of content.

In operation 607, the processor may form a table, which is used for multiple pieces of content (e.g., the part of tagging target content and the part of tag object content) having a tag relation therebetween, in a memory (see reference numeral 130 of FIG. 1). According to certain embodiments, the processor may include at least one of metadata information, identification information (e.g., URL, URI, or the like), subject information, content creation date information, or content create location information, which serves as link information between the multiple pieces of content, in the table. The table may support accessibility to at least one part of tag object content (or a part of tagging target content having a tag relation with the part of tag object content) having a tag relation with a part of tagging target content and may serve as a reference made to the identification of the tag relation with specific content.

According to various embodiments, a method for tagging content of an electronic device, may include outputting a screen for at least one part of first content, which is accompanied in an operation of using a function of the electronic device or is selected from an execution screen of a specific application program by a user, outputting a user interface, which supports tagging settings for the at least one part of first content, onto at least one area of the screen for the at least one part of first content, including at least one part of second content, which corresponds to information on the at least one part of first content, in at least one area of the user interface, tagging the at least one part of second content on the at least one part of first content if a user input is applied to the at least one part of second content, and forming a table for multiple pieces of content having a tag relation between the multiple pieces of content.

According to various embodiments, outputting the user interface may include presenting at least one part of second content, which includes an object corresponding to the at least one part of first content, in at least one area of the user interface.

According to various embodiments, outputting the user interface may include presenting at least one part of second content, which includes location information corresponding to the at least one part of first content, in at least one area of the user interface.

According to various embodiments, outputting the user interface may include presenting at least one part of second content, which includes date information corresponding to the at least one part of first content, in at least one area of the user interface.

According to various embodiments, outputting the user interface may include, if multiple functions of the electronic device are simultaneously used, presenting at least one part of content related to the use of the multiple functions in at least one area of the user interface.

According to various embodiments, tagging the at least one part of second content to the at least one part of first content may include including metadata information or identification information of the at least one part of second content in metadata of the at least one part of first content.

According to various embodiments, tagging the at least one part of second content to the at least one part of first content may include, if the at least one part of second content is tagged on the at least one part of first content, presenting metadata information or identification information of the at least one part of first content in metadata of the at least one part of second content.

According to various embodiments, forming the table may include including, in the table, at least one of metadata information or identification information of each of multiple pieces of content having a tag relation between the multiple pieces of content, or link factor information between the multiple pieces of content.

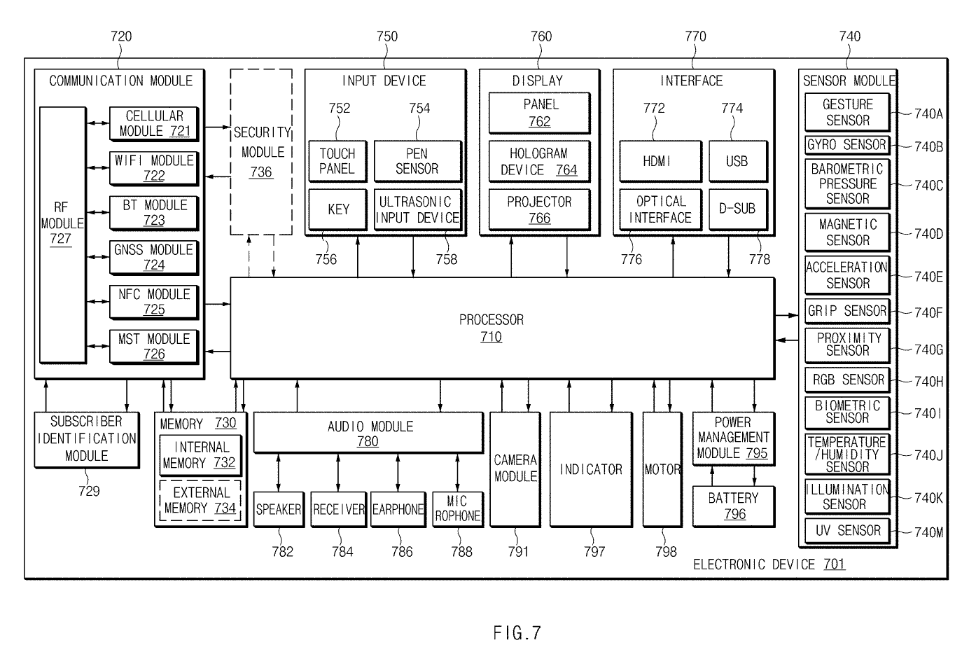

FIG. 7 illustrates a block diagram of an electronic device, according to certain embodiments.

Referring to FIG. 7, the electronic device 701 may include one or more processors 710 (e.g., application processors (APs)), a communication module 720, a subscriber identification module (SIM) 729, a memory 730, a security module 736, a sensor module 740, an input device 750, a display 760, an interface 770, an audio module 780, a camera module 791, a power management module 795, a battery 796, an indicator 797, and a motor 798.

The processor 710 may drive, for example, an operating system (OS) or an application program to control a plurality of hardware or software components connected thereto and may process and compute a variety of data. The processor 710 may be implemented with, for example, a system on chip (SoC). According to certain embodiments of the present disclosure, the processor 710 may include a graphic processing unit (GPU) (not shown) and/or an image signal processor (not shown). The processor 710 may include at least some (e.g., a cellular module 721) of the components shown in FIG. 7. The processor 710 may load a command or data received from at least one of other components (e.g., a non-volatile memory) into a volatile memory to process the data and may store various data in a non-volatile memory.

The communication module 720 may include, for example, the cellular module 721, a wireless-fidelity (Wi-Fi) module 722, a Bluetooth (BT) module 723, a global navigation satellite system (GNSS) module 724 (e.g., a GPS module, a Gleans module, a Bijou module, or a Galileo module), a near field communication (NFC) module 725, an MST module 726, and a radio frequency (RF) module 727.

The cellular module 721 may provide, for example, a voice call service, a video call service, a text message service, or an Internet service, and the like through a communication network. According to certain embodiments of the present disclosure, the cellular module 721 may identify and authenticate the electronic device 701 in a communication network using the SIM 729 (e.g., a SIM card). According to certain embodiments of the present disclosure, the cellular module 721 may perform at least part of functions which may be provided by the processor 710. According to certain embodiments of the present disclosure, the cellular module 721 may include a communication processor (CP).

The Wi-Fi module 722, the BT module 723, the GNSS module 724, the NFC module 725, or the MST module 726 may include, for example, a processor for processing data transmitted and received through the corresponding module. According to various embodiments of the present disclosure, at least some (e.g., two or more) of the cellular module 721, the Wi-Fi module 722, the BT module 723, the GNSS module 724, the NFC module 725, or the MST module 726 may be included in one integrated chip (IC) or one IC package.

The RF module 727 may transmit and receive, for example, a communication signal (e.g., an RF signal). Though not shown, the RF module 727 may include, for example, a transceiver, a power amplifier module (PAM), a frequency filter, or a low noise amplifier (LNA), or an antenna, and the like. According to another embodiment of the present disclosure, at least one of the cellular module 721, the Wi-Fi module 722, the BT module 723, the GNSS module 724, the NFC module 725, or the MST module 726 may transmit and receive an RF signal through a separate RF module.

The SIM 729 may include, for example, a card which includes a SIM and/or an embedded SIM. The SIM 729 may include unique identification information (e.g., an integrated circuit card identifier (ICCID)) or subscriber information (e.g., an international mobile subscriber identity (IMSI)).

The memory 730 may include, for example, an embedded memory 732 or an external memory 734. The embedded memory 732 may include at least one of, for example, a volatile memory (e.g., a dynamic random access memory (DRAM), a static RAM (SRAM), a synchronous dynamic RAM (SDRAM), and the like), or a non-volatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory or a NOR flash memory, and the like), a hard drive, or a solid state drive (SSD)).

The external memory 734 may include a flash drive, for example, a compact flash (CF), a secure digital (SD), a micro-SD, a mini-SD, an extreme digital (xD), a multimedia car (MMC), or a memory stick, and the like. The external memory 734 may operatively and/or physically connect with the electronic device 701 through various interfaces.

The security module 736 may be a module which has a relatively higher secure level than the memory 730 and may be a circuit which stores secure data and guarantees a protected execution environment. The security module 736 may be implemented with a separate circuit and may include a separate processor. The security module 736 may include, for example, an embedded secure element (eSE) which is present in a removable smart chip or a removable SD card or is embedded in a fixed chip of the electronic device 701. Also, the security module 736 may be driven by an operating system different from the operating system of the electronic device 701. For example, the security module 736 may operate based on a java card open platform (JCOP) operating system.

The sensor module 740 may measure, for example, a physical quantity or may detect an operation state of the electronic device 701, and may convert the measured or detected information to an electric signal. The sensor module 740 may include at least one of, for example, a gesture sensor 740A, a gyro sensor 740B, a barometric pressure sensor 740C, a magnetic sensor 740D, an acceleration sensor 740E, a grip sensor 740F, a proximity sensor 740G, a color sensor 740H (e.g., red, green, blue (RGB) sensor), a biometric sensor 740I, a temperature/humidity sensor 740J, an illumination sensor 740K, or an ultraviolet (UV) sensor 740M. Additionally or alternatively, the sensor module 740 may further include, for example, an e-nose sensor (not shown), an electromyography (EMG) sensor (not shown), an electroencephalogram (EEG) sensor (not shown), an electrocardiogram (ECG) sensor (not shown), an infrared (IR) sensor (not shown), an iris sensor (not shown), and/or a fingerprint sensor (not shown), and the like. The sensor module 740 may further include a control circuit for controlling at least one or more sensors included therein. According to various embodiments of the present disclosure, the electronic device 701 may further include a processor configured to control the sensor module 740, as part of the processor 710 or to be independent of the processor 710. While the processor 710 is in a sleep state, the electronic device 701 may control the sensor module 740.

The input device 750 may include, for example, a touch panel 752, a (digital) pen sensor 754, a key 756, or an ultrasonic input device 758. The touch panel 752 may use at least one of, for example, a capacitive type, a resistive type, an infrared type, or an ultrasonic type. Also, the touch panel 752 may further include a control circuit. The touch panel 752 may further include a tactile layer and may provide a tactile reaction to a user.

The (digital) pen sensor 754 may be, for example, part of the touch panel 752 or may include a separate sheet for recognition. The key 756 may include, for example, a physical button, an optical key, or a keypad. The ultrasonic input device 758 may allow the electronic device 701 to detect a sound wave using a microphone (e.g., a microphone 788) and to verify data through an input tool generating an ultrasonic signal.

The display 760 may include a panel 762, a hologram device 764, or a projector 766. The panel 762 may be implemented to be, for example, flexible, transparent, or wearable. The panel 762 and the touch panel 752 may be integrated into one module. The hologram device 764 may show a stereoscopic image in a space using interference of light. The projector 766 may project light onto a screen to display an image. The screen may be positioned, for example, inside or outside the electronic device 701. According to certain embodiments of the present disclosure, the display 760 may further include a control circuit for controlling the panel 762, the hologram device 764, or the projector 766.

The interface 770 may include, for example, a high-definition multimedia interface (HDMI) 772, a universal serial bus (USB) 774, an optical interface 776, or a D-subminiature 778. Additionally or alternatively, the interface 770 may include, for example, a mobile high definition link (MHL) interface, an SD card/multimedia card (MMC) interface, or an infrared data association (IrDA) standard interface.

The audio module 780 may convert a sound and an electric signal in dual directions. The audio module 780 may process sound information input or output through, for example, a speaker 782, a receiver 784, an earphone 786, or the microphone 788, and the like.

The camera module 791 may be a device which captures a still image and a moving image. According to certain embodiments of the present disclosure, the camera module 791 may include one or more image sensors (not shown) (e.g., a front sensor or a rear sensor), a lens (not shown), an image signal processor (ISP) (not shown), or a flash (not shown) (e.g., an LED or a xenon lamp).

The power management module 795 may manage, for example, power of the electronic device 701. According to certain embodiments of the present disclosure, though not shown, the power management module 795 may include a power management integrated circuit (PMIC), a charger IC or a battery or fuel gauge. The PMIC may have a wired charging method and/or a wireless charging method. The wireless charging method may include, for example, a magnetic resonance method, a magnetic induction method, or an electromagnetic method, and the like. An additional circuit for wireless charging, for example, a coil loop, a resonance circuit, or a rectifier, and the like may be further provided. The battery gauge may measure, for example, the remaining capacity of the battery 796 and voltage, current, or temperature thereof while the battery 796 is charged. The battery 796 may include, for example, a rechargeable battery or a solar battery.

The indicator 797 may display a specific state of the electronic device 701 or part (e.g., the processor 710) thereof, for example, a booting state, a message state, or a charging state, and the like. The motor 798 may convert an electric signal into mechanical vibration and may generate vibration or a haptic effect, and the like. Though not shown, the electronic device 701 may include a processing unit (e.g., a GPU) for supporting a mobile TV. The processing unit for supporting the mobile TV may process media data according to standards, for example, a digital multimedia broadcasting (DMB) standard, a digital video broadcasting (DVB) standard, or a MediaFLO™ standard, and the like.

Each of the above-mentioned elements of the electronic device according to various embodiments of the present disclosure may be configured with one or more components, and names of the corresponding elements may be changed according to the type of the electronic device. The electronic device according to various embodiments of the present disclosure may include at least one of the above-mentioned elements, some elements may be omitted from the electronic device, or other additional elements may be further included in the electronic device. Also, some of the elements of the electronic device according to various embodiments of the present disclosure may be combined with each other to form one entity, thereby making it possible to perform the functions of the corresponding elements in the same manner as before the combination.

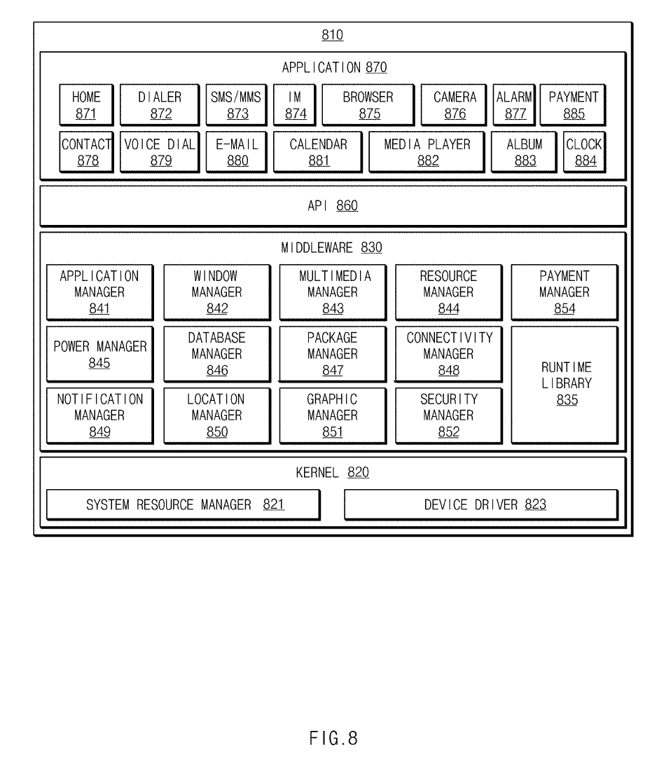

FIG. 8 illustrates a block diagram of a program module, according to at least one embodiment of the present disclosure.

According to certain embodiments of the present disclosure, the program module 810 may include an operating system (OS) for controlling resources associated with an electronic device (e.g., an electronic device 701 of FIG. 7) and/or various applications which are executed on the operating system. The operating system may be, for example, Android, iOS, Windows, Symbian, Tizen, or Bada, and the like.

The program module 810 may include a kernel 820, a middleware 830, an application programming interface (API) 860, and/or an application 870. At least part of the program module 810 may be preloaded on the electronic device, or may be downloaded from an external electronic device.

The kernel 820 may include, for example, a system resource manager 821 and/or a device driver 823. The system resource manager 821 may control, assign, or collect, and the like system resources. According to certain embodiments of the present disclosure, the system resource manager 821 may include a process management unit, a memory management unit, or a file system management unit, and the like. The device driver 823 may include, for example, a display driver, a camera driver, a Bluetooth® (BT) driver, a shared memory driver, a universal serial bus (USB) driver, a keypad driver, a wireless-fidelity (Wi-Fi) driver, an audio driver, or an inter-process communication (IPC) driver.

The middleware 830 may provide, for example, functions the application 870 needs in common, and may provide various functions to the application 870 through the API 860 such that the application 870 efficiently uses limited system resources in the electronic device. According to certain embodiments of the present disclosure, the middleware 830 may include at least one of a runtime library 835, an application manager 841, a window manager 842, a multimedia manager 843, a resource manager 844, a power manager 845, a database manager 846, a package manager 847, a connectivity manager 848, a notification manager 849, a location manager 850, a graphic manager 851, a security manager 852, or a payment manager 854.

The runtime library 835 may include, for example, a library module used by a compiler to add a new function through a programming language while the application 870 is executed. The runtime library 835 may perform a function about input and output management, memory management, or an arithmetic function.

The application manager 841 may manage, for example, a life cycle of at least one application 870. The window manager 842 may manage graphic user interface (GUI) resources used on a screen of the electronic device. The multimedia manager 843 may determine a format utilized for reproducing various media files and may encode or decode a media file using a codec corresponding to the corresponding format. The resource manager 844 may manage source codes of at least one application 870, and may manage resources of a memory or a storage space, and the like.

The power manager 845 may act together with, for example, a basic input/output system (BIOS) and the like, may manage a battery or a power source, and may provide power information utilized for an operation of the electronic device. The database manager 846 may generate, search, or change a database to be used in at least one of the application 870. The package manager 847 may manage installation or update of an application distributed by a type of a package file.

The connectivity manager 848 may manage, for example, wireless connection such as Wi-Fi connection or BT connection, and the like. The notification manager 849 may display or notify events, such as an arrival message, an appointment, and proximity notification, by a method which is not disturbed to the user. The location manager 850 may manage location information of the electronic device. The graphic manager 851 may manage a graphic effect to be provided to the user or a user interface (UI) related to the graphic effect. The security manager 852 may provide all security functions utilized for system security or user authentication, and the like. According to certain embodiments of the present disclosure, when the electronic device has a phone function, the middleware 830 may further include a telephony manager (not shown) for managing a voice or video communication function of the electronic device.

The middleware 830 may include a middleware module which configures combinations of various functions of the above-described components. The middleware 830 may provide a module which specializes according to various types of operating systems to provide a differentiated function. Also, the middleware 830 may dynamically delete some of old components or may add new components.

The API 860 may be, for example, a set of API programming functions, and may be provided with different components according to various operating systems. For example, in case of Android or iOS, one API set may be provided according to platforms. In case of Tizen, two or more API sets may be provided according to platforms.

The application 870 may include one or more of, for example, a home application 871, a dialer application 872, a short message service/multimedia message service (SMS/MMS) application 873, an instant message (IM) application 874, a browser application 875, a camera application 876, an alarm application 877, a contact application 878, a voice dial application 879, an e-mail application 880, a calendar application 881, a media player application 882, an album application 883, a clock application 884, a payment application 885, a health care application (e.g., an application for measuring quantity of exercise or blood sugar, and the like), or an environment information application (e.g., an application for providing atmospheric pressure information, humidity information, or temperature information, and the like), and the like.

According to certain embodiments of the present disclosure, the application 870 may include an application (hereinafter, for better understanding and ease of description, referred to as “information exchange application”) for exchanging information between the electronic device (e.g., the electronic device 701 of FIG. 7) and an external electronic device. The information exchange application may include, for example, a notification relay application for transmitting specific information to the external electronic device or a device management application for managing the external electronic device.

For example, the notification relay application may include a function of transmitting notification information, which is generated by other applications (e.g., the SMS/MMS application, the e-mail application, the health care application, or the environment information application, and the like) of the electronic device, to the external electronic device. Also, the notification relay application may receive, for example, notification information from the external electronic device, and may provide the received notification information to the user of the electronic device.

The device management application may manage (e.g., install, delete, or update), for example, at least one (e.g., a function of turning on/off the external electronic device itself (or partial components) or a function of adjusting brightness (or resolution) of a display) of functions of the external electronic device which communicates with the electronic device, an application which operates in the external electronic device, or a service (e.g., a call service or a message service) provided from the external electronic device.

According to certain embodiments of the present disclosure, the application 870 may include an application (e.g., the health card application of a mobile medical device) which is preset according to attributes of the external electronic device. According to certain embodiments of the present disclosure, the application 870 may include an application received from the external electronic device. According to certain embodiments of the present disclosure, the application 870 may include a preloaded application or a third party application which may be downloaded from a server. Names of the components of the program module 810 according to various embodiments of the present disclosure may differ according across operating systems.

According to various embodiments of the present disclosure, at least part of the program module 810 may be implemented with software, firmware, hardware, or at least two or more combinations thereof. At least part of the program module 810 may be implemented (e.g., executed) by, for example, a processor (e.g., a processor 710). At least part of the program module 810 may include, for example, a module, a program, a routine, sets of instructions, or a process, and the like for performing one or more functions.

The term “module” used herein may represent, for example, a unit including one of hardware, software and firmware or a combination thereof. The term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” may include at least one of an application-specific integrated circuit (ASIC) chip, a field-programmable gate array (FPGA), and a programmable-logic device for performing some operations, which are known or will be developed.

At least a part of devices (e.g., modules or functions thereof) or methods (e.g., operations) according to various embodiments of the present disclosure may be implemented as instructions stored in a computer-readable storage medium in the form of a program module. In the case where the instructions are performed by a processor (e.g., the processor 710), the processor may perform functions corresponding to the instructions. The computer-readable storage medium may be, for example, the memory 730.

A computer-readable recording medium may include a hard disk, a floppy disk, a magnetic medium (e.g., a magnetic tape), an optical medium (e.g., CD-ROM, digital versatile disc (DVD)), a magneto-optical medium (e.g., a floptical disk), or a hardware device (e.g., a ROM, a RAM, a flash memory, or the like). The program instructions may include machine language codes generated by compilers and high-level language codes that can be executed by computers using interpreters. The above-mentioned hardware device may be configured to be operated as one or more software modules for performing operations of various embodiments of the present disclosure and vice versa.

A module or a program module according to various embodiments of the present disclosure may include at least one of the above-mentioned elements, or some elements may be omitted or other additional elements may be added. Operations performed by the module, the program module or other elements according to various embodiments of the present disclosure may be performed in a sequential, parallel, iterative or heuristic way. Furthermore, some operations may be performed in another order or may be omitted, or other operations may be added.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An electronic device comprising:
a communication module configured to support communication with an external device;
a memory configured to store at least one content; and
a processor electrically connected with the communication module and the memory,
wherein the processor is configured to:
tag at least one part of first content, which is acquired from the memory, and at least one part of second content, which is acquired from the memory or the external device, on each other based on a specified link factor; and
form link information between the at least one part of first content and the at least one part of second content in a form of a table.

2. The electronic device of claim 1, wherein the processor is configured to:
output a user interface, which supports tagging settings between the at least one part of first content and the at least one part of second content, onto at least a portion of a screen area for the at least one part of first content.

3. The electronic device of claim 2, wherein the processor is configured to:
include at least one part of second content, which includes an object corresponding to the at least one part of first content, in at least one area of the user interface.

4. The electronic device of claim 2, wherein the processor is configured to:
include at least one part of second content, which includes location information corresponding to the at least one part of first content, in at least one area of the user interface.

5. The electronic device of claim 2, wherein the processor is configured to:
include at least one part of second content, which includes date information corresponding to the at least one part of first content, in at least one area of the user interface.

6. The electronic device of claim 2, wherein the processor is configured to:
if multiple functions of the electronic device are simultaneously and integrally used,
include at least one part of content related to use of multiple functions in the user interface.

7. The electronic device of claim 1, wherein the processor is configured to:
determine at least one part of first content, which is accompanied in an operation of using a function of the electronic device or is selected from an execution screen of a specific application program by a user, as a part of tagging target content.

8. The electronic device of claim 2, wherein the processor is configured to:
determine at least one part of second content, which is selected from the user interface by a user, as a part of tag object content.

9. The electronic device of claim 1, wherein the processor is configured to:
include metadata information or identification information of the at least one part of second content in metadata of the at least one part of first content to tag the at least one part of second content on the at least one part of first content.

10. The electronic device of claim 9, wherein the processor is configured to:
if the at least one part of second content is tagged on the at least one part of first content,
include metadata information or identification information of the at least one part of first content in metadata of the at least one part of second content to tag the at least one part of first content on the at least one part of second content.

11. The electronic device of claim 1, wherein the processor is configured to:
include, in the table, at least one of metadata information or identification information of each of multiple pieces of content having a tag relation between the multiple pieces of content, or link factor information between the multiple pieces of content.

12. The electronic device of claim 1, wherein the processor is configured to:
include the at least one part of first content and the at least one part of second content in a single screen of an execution screen of an application program related to tagging.

13. A method for tagging content of an electronic device, the method comprising:
outputting a screen for at least one part of first content, which is accompanied in an operation of using a function of the electronic device or is selected from an execution screen of a specific application program by a user;
outputting a user interface, which supports tagging settings for the at least one part of first content, onto at least one area of the screen for the at least one part of first content;
including at least one part of second content, which corresponds to information on the at least one part of first content, in at least one area of the user interface;
tagging the at least one part of second content on the at least one part of first content if a user input is applied to the at least one part of second content; and
forming a table for multiple pieces of content having a tag relation between the multiple pieces of content.

14. The method of claim 13, wherein the outputting of the user interface includes:
including at least one part of second content, which includes an object corresponding to the at least one part of first content, in at least one area of the user interface.

15. The method of claim 13, wherein the outputting of the user interface includes:
including at least one part of second content, which includes location information corresponding to the at least one part of first content, in at least one area of the user interface.

16. The method of claim 13, wherein the outputting of the user interface includes:
including at least one part of second content, which includes date information corresponding to the at least one part of first content, in at least one area of the user interface.

17. The method of claim 13, wherein the outputting of the user interface includes:
if multiple functions of the electronic device are simultaneously used,
including at least one part of content related to use of multiple functions in at least one area of the user interface.

18. The method of claim 13, wherein the tagging of the at least one part of second content on the at least one part of first content includes:
including metadata information or identification information of the at least one part of second content in metadata of the at least one part of first content.

19. The method of claim 18, wherein the tagging of the at least one part of second content on the at least one part of first content further includes:
if the at least one part of second content is tagged on the at least one part of first content,
including metadata information or identification information of the at least one part of first content in metadata of the at least one part of second content.

20. The method of claim 13, wherein the forming of the table includes:
including, in the table, at least one of metadata information or identification information of each of the multiple pieces of content having the tag relation between the multiple pieces of content, or link factor information between the multiple pieces of content.
